(19) United States
(12) Patent Application Publication
(10) Pub. No.: US 2010/0218645 A1
(43) Pub. Date: Sep. 2, 2010

(54) METHOD OF REMOVAL OF HEAVY METAL IONS FROM WATER

(75) Inventors: Aharon Gedanken, Givataim (IL); Elisha Tel-Or, Kfar Bilu (IL); Benny Chefetz, Kidron (IL); Smadar Elmeshaly, Holon (IL)

Correspondence Address: BROWDY AND NEIMARK, P.L.L.C.;624 NINTH STREET, NW, SUITE 300, WASHINGTON, DC, 20001-5303, US

(73) Assignees: BAR-ILAN UNIVERSITY, Ramat Gan (IL); YISSUM RESEARCH DEVELOPMENT COMPANY OF THE HEBREW, Jerusalem (IL)

(21) Appl. No.: 12/161,338

(22) PCT Filed: Jan. 17, 2007
(86) PCT No.: PCT/IL2007/000063

§ 371 Date: Nov. 27, 2009

Related U.S. Application Data
(60) Provisional application No. 60/759,075, filed on Jan. 17, 2006.

(51) Int. Cl. B22F 9/18; C02F 3/32; C02F 1/62; C02F 1/30

(52) U.S. Cl. 75/345; 210/602; 210/748.07; 977/895

(57) ABSTRACT

A method for removal of heavy metal ions from water including submerging an aquatic plant or dried material thereof in said water and subsequently irradiating the water in which the aquatic plant or dried material has been submerged with microwave irradiation.

### FIELD OF THE INVENTION

The present invention relates to a method of removal of heavy metal ions from water by adsorption of said heavy metal ions on aquatic plants. The heavy metal can be recovered as metallic nanoparticles.

### BACKGROUND OF THE INVENTION

Heavy metals are toxic inorganic contaminants that, unlike organic contaminants that can be degraded by microorganisms, must be removed from wastewater before being discharged to the environment. A wide range of physical and chemical processes is available for the removal of heavy metal ions during wastewater treatment. These include ion exchange, electrochemical precipitation, filtration and adsorption in commercial activated carbon. A major drawback with precipitation is contamination of the produced sludge that limits its application in agricultural fields. Ion exchange and adsorption in activated carbon are efficient treatments but they are not largely used due to the high operational cost.

Alternatively, aquatic plant materials have shown a remarkably high adsorption capacity for heavy metals from water (Ajmal et al., 2000; Kadirvelu et al., 2000; Oliveira et al., 2004; Wase and Forster, 1997), as well as from regular aqueous solutions of the ions. Thus, plant materials that are available in large quantities may have the potential to be used as alternatively low-cost (1$ per 1 kg of aquatic plant) and environmentally friendly adsorbents. Such a system for reducing the concentration of a heavy metal ion in a water supply, in which aquatic plant is capable of effecting bioremediation of the heavy metal ion in the water supply, is disclosed in U.S. Pat. No. 6,508,033.

The present inventors recently disclosed a new approach for the removal of heavy metal ions from water, using a combined procedure composed of two technologies, namely, spontaneous adsorption of heavy metal ions on aquatic plants and conversion of the adsorbed heavy metal ions into the corresponding metallic nanoparticles by the polyol reaction carried out in a microwave oven (Chefetz et al., 2005). As shown in said publication, the complete spontaneous adsorption of Ag⁺¹ ions on the aquatic plants Azolla filiculoides took a few days (about 7 days). Reduction of the adsorbed heavy metal ions to the metallic nanoparticles was carried out by microwave irradiation for 3 minutes of an ethylene glycol solution of the Ag⁺¹-adsorbed plant biomass.

### SUMMARY OF THE INVENTION

It has now been unexpectedly found in accordance with the present invention that the adsorption of heavy metal ions on an aquatic plant may be dramatically accelerated, namely, significantly shortened, in case the water containing said heavy metal ions are irradiated with microwave irradiation subsequently after an aquatic plant or dried material thereof was submerged therein. This irradiation-assisted adsorption of the heavy metal ions takes several minutes as compared to the ˜7 days spontaneous adsorption described by Chefetz et al. (2005). Furthermore, the inventors of the present invention have found that the adsorbed metal ions can be reduced to the corresponding nanometal particles by the microwave irradiation without the addition of a reducing agent such as ethylene glycol. As a consequence of that, the whole process of removal of heavy metal ions from water and of recovery of the metallic nanoparticles may be conducted in one step in a short time under microwave irradiation with no need for external agents.

In one aspect, the present invention thus relates to a method for removal of heavy metal ions from water comprising: (i) submerging an aquatic plant or dried material thereof in said water and (ii) subsequently irradiating the water of (i) with microwave irradiation.

In another aspect, the present invention relates to a method for recovery of nanoparticles of a heavy metal from water containing ions of said heavy metal, comprising:

(i) submerging an aquatic plant or dried material thereof in said water;

(ii) subsequently irradiating the water of (i) with microwave irradiation, thus causing enhanced adsorption of said heavy metal ions onto the aquatic plant and reduction of the heavy metal ions to heavy metal nanoparticles; and

(iii) recovery of the heavy metal nanoparticles from the aquatic plant.

In preferred embodiments, the methods of the present invention are used for treatment of wastewater.

### DETAILED DESCRIPTION OF THE INVENTION

As found in accordance with the present invention, microwave irradiation significantly accelerates the adsorption of heavy metal ions on aquatic plants or dried material thereof as compared to the spontaneous adsorption in the absence of such irradiation. Furthermore, the adsorbed heavy metal ions can be reduced to the corresponding metallic nanoparticles by the microwave irradiation without the addition of a reducing agent. This enables removal of heavy metal ions from water, and recovering marketable metallic nanoparticles from water containing heavy metal ions in a short, cost-effective manner.

Both methods of the present invention comprising the adsorption of said heavy metal ions on an aquatic plant or dried material thereof under microwave irradiation, whereas the recovering of metallic nanoparticles further requires the conversion of the adsorbed heavy metal ions into metallic nanoparticles and the separation of the obtained nanoparticles from the aquatic plant.

The term “enhanced adsorption” as used herein refers to the kinetic of a complete adsorption process of heavy metal ions on an aquatic plant or dried material thereof, that is at least 50-fold, preferably at least 100-fold, more preferably at least 200-fold faster than the known adsorption of heavy metal ions on an aquatic plant, as previously described (Chefetz et al., 2005).

The microwave irradiation of the water to be treated according to the methods of the present invention is performed subsequently, namely, less than 10 hours, after submerging the aquatic plant in the water. The irradiation may be carried out utilizing any known microwave device as known in the art and will be selected according to the volume and other parameters of the water to be treated. The intensity and duration of the irradiation are determined so as to cause adsorption of the heavy metal ions on the aquatic plant and reduction of the adsorbed heavy metal ions to heavy metal nanoparticles. Said intensity and duration may be influenced by various parameters such as the volume of the water to be treated; the specific species of aquatic plant used in the process and its mass; and the heavy metal ions to be adsorbed and their concentration. Furthermore, it should be noted that in certain cases, specific heavy metal ions may be adsorbed at different efficiencies on different species of aquatic plants and, similarly, different heavy metal ions may be adsorbed at different efficiencies on the same species of aquatic plant.

The aquatic plant for use in the methods of the present invention may be any species of a plant that grows in, lives in, or lives on water, or combinations thereof, such as, without being limited to, the free floating plants Azolla filiculoides, Pistia stratiotes or a combination thereof. As defined by the present invention, the aquatic plant may be in the natural form, namely, whole plant, leaves, root, etc., or as a dried material obtained, for example, after dehydrating said aquatic plant in an oven.

In preferred embodiments, the aquatic plant used in the methods of the invention is dried leaves of Azolla filiculoides or Pistia stratiotes, preferably Azolla filiculoides, obtained after dehydrating said leaves in an oven at 80° C. for ˜2 days.

The term “heavy metal” as used herein refers to any metallic element of the periodic table having a specific gravity of approximately 5.0 or higher, such as Ag, Pb, Ru, Hg, Fe, Cu, Pt, Co and Ni, and/or metals that have a standard reduction potential (E⁰) higher than −0.4 Volts. In one embodiment, the heavy metal ions are Ag⁺ ions, found for example in photoprocessing wastewater. In another embodiment, the heavy metal ions are Pb⁺² ions.

The reduction of the adsorbed heavy metal ions to the corresponding metallic nanoparticles may be performed in the presence of a reducing agent such as ethylene glycol. However, as found in accordance with the present invention, the reduction of the adsorbed metallic ions into metallic nanoparticles occurs during the microwave irradiation also without the addition of ethylene glycol, indicating that it is done by the aquatic plant itself.

The separation of the metallic nanoparticles from the aquatic plant biomass is carried out by methods well known in the art, for example, by heating the aquatic plant biomass under inert atmosphere using a noble gas such as Argon.

The invention will now be illustrated by the following non-limiting Examples.

### EXAMPLES

### Experimental

Azolla filiculoides was grown in IRRI medium (Kuyucak and Volesky, 1989) in the phytothron of the Faculty of Agriculture, Hebrew University of Jerusalem (Rehovot, Israel).

The starting material for the reduction of Ag⁺ ions was silver nitrate. The quantity of the Ag⁺ ions adsorbed by the aquatic plant biomass was calculated by differences between the Ag⁺ concentration in the solution and the original amount. The concentration of Ag⁺ ions in the solution was determined using a well-known titration method, in which the Ag⁺ ions are titrated with a 0.01M solution of potassium thiocyanate (KSCN) in the presence of FeCl₃ as an indicator (Kolthoff and Sandell, 1958). According to this method, only after all the silver ions in the solution have been precipitated by the thiocyanate, the excess of thiocyanate reacts with the Fe⁺³ ions generating a deep red complex of FeSCN⁺² ions.

The starting material for the reduction of Pb⁺² ions was Pb(NO₃)₂. The quantity of the Pb⁺² ions adsorbed by the aquatic plant biomass was calculated using the same method described above and the concentration of Pb⁺² ions in the solution was determined by a titration with ethylene diamine tetraacetic acid (EDTA), forming a red and relatively stable complex.

An ordinary household microwave oven (Spectra 900 W, 2.45 GHz), modified with a refluxing system, was used.

### Example 1

### Adsorption of Silver Ions on Azolla filiculoides and Pistia stratiotes

0.75 g of dried leaves of the aquatic plant Azolla filiculoides, obtained by dehydrating said leaves in an oven for ˜2 days at 80° C., was submerged in a 0.02 M silver ion aqueous solution with or without ethylene glycol. Both the ethylene glycol and the aqueous solutions were microwave irradiated. The silver ions were adsorbed on the aquatic plant biomass and reduced, generating silver nanoparticles, and the concentration of the silver ions in the solution was monitored, taking aliquots out of the solution and titrating them for silver ions determination. In both cases, after 3 minutes of irradiation, the titration did not yield any appreciable amount of silver ions left. No precipitate of silver ions was found on the bottom of the glass cylinder. No appreciable amount of silver ions was left in both ethylene glycol and aqueous solutions, indicating that the reduction of silver ions to nanoparticles was done by the aquatic plant biomass and not necessarily by the ethylene glycol.

Identical experiments have been done with the aquatic plant Pistia stratiotes and similar results have been observed.

### Example 2

### Adsorption of Lead Ions on Azolla filiculoides and Pistia stratiotes

The adsorption of lead ions on the aquatic plants Azolla filiculoides and Pistia stratiotes has been tested as described in Example 1 above.

As with the silver ions, both in the ethylene glycol and the aqueous solutions, after 3 minutes of microwave irradiation, no appreciable amount of lead ions was left in the solution and no precipitate of lead ions was found on the bottom of the glass cylinder.

### REFERENCES

Ajmal, A. Rao, R. A. K. Rais, A. Jameel, A., Recovery of Ni(II) from electroplating wastewater, J. Haz. Mater. B 2000, 79, 117-131

Chefetz, B. Sominski, L. Pinchas, M. Ginsburg, T. Elmachliy, S. Tel-Or, E. and Gedanken, A., New approach for the removal of metal ions from water: adsorption onto aquatic plants and microwave reaction for the fabrication of nanometals, J. Phys. Chem. B Letters 2005, 109, 15179-15181

Kadirvelu, K. Faur-Brasquet, C. Le Cloirec, P., Removal of Cu(II), Pb(II), and Ni(II) by adsorption onto activated carbon cloths, Langmuir 2000, 16, 8404-8409

Kolthoff, I. M. Sandell, Ea, Textbook of Quantitative Inorganic Analysis, 3rd ed., Macmillan: New York, 1958

Kuyucak, N. Volesky, B., Biosorbents for recovery of metals from industrial solutions, Biotechnol. Letts., 1989, 10, 137-142

Oliveira, L. C. A. Petkowicz, D. I. Smaniotto, A. Pergher, S. B. C., Magnetic zeolites: a new adsorbent for removal of Metallic contaminants from water, Water Res. 2004, 38, 3699-3704

Wase, D. A. J. Forster, C. F., Biosorbents for Metal Ions, Taylor and Francis: London, 1997

1. A method for removal of heavy metal ions from water comprising: (i) submerging an aquatic plant or dried material thereof in said water and (ii) subsequently irradiating the water of (i) with microwave irradiation.

2. The method of claim 1, wherein said irradiation is performed less than 10 h after submerging said aquatic plant or dried material thereof in the water.

3. The method of claim 1, wherein said irradiation is of intensity and/or duration so as to cause adsorption of the heavy metal ions on the aquatic plant and reduction of the adsorbed heavy metal ions to heavy metal nanoparticles.

4. The method of claim 1, wherein said aquatic plant is at least one species of a plant that grows in, lives in, or lives on water.

5. The method of claim 4, wherein said aquatic plant is Azolla filiculoides, Pistia stratiotes or a combination thereof.

6. The method of claim 4, wherein said dried material is obtained after dehydrating said aquatic plant in an oven.

7. The method of claim 1, wherein said heavy metal ions are Ag, Pb, Ru, Hg, Fe, Cu, Pt, Co or Ni ions, and/or ions of metals that have a standard reduction potential higher than −0.4 Volts.

8. The method of claim 7, wherein said heavy metal ions are Ag⁺ or Pb⁺² ions.

9. The method of claim 1, for removal of heavy metal ions from wastewater.

10. The method according to claim 1, further comprising recovery of the metal from the metal ions adsorbed on the aquatic plant.

11. The method according to claim 10, wherein said metal is recovered as metal nanoparticles.

12. A method for recovery of nanoparticles of a heavy metal from water containing ions of said heavy metal, comprising:
(i) submerging an aquatic plant or dried material thereof in said water;
(ii) subsequently irradiating the water of (i) with microwave irradiation, thus causing enhanced adsorption of said heavy metal ions onto the aquatic plant and reduction of the heavy metal ions to heavy metal nanoparticles; and
(iii) recovery of the heavy metal nanoparticles from the aquatic plant.

13. The method of claim 12, wherein said irradiation is performed less than 10 h after submerging said aquatic plant or dried material thereof in the water.

14. The method of claim 12, wherein said irradiation is of intensity and/or duration so as to cause adsorption of the heavy metal ions on the aquatic plant and reduction of the adsorbed heavy metal ions to heavy metal nanoparticles.

15. The method of claim 12, wherein said aquatic plant is at least one species of a plant that grows in, lives in, or lives on water.

16. The method of claim 15, wherein said aquatic plant is Azolla filiculoides, Pistia stratiotes or a combination thereof.

17. The method of claim 15, wherein said dried material is obtained after dehydrating said aquatic plant in an oven.

18. The method of claim 12, wherein said heavy metal ions are Ag, Pb, Ru, Hg, Fe, Cu, Pt, Co or Ni ions, and/or ions of metals that have a standard reduction potential higher than −0.4 Volts.

19. The method of claim 18, wherein said heavy metal ions are Ag⁺ or Pb⁺² ions.

20. The method of claim 12, for recovery of nanoparticles of a heavy metal from wastewater containing ions of said heavy metal.
